(19) United States
(12) Patent Application Publication
(10) Pub. No.: US 2023/0373189 A1
(43) Pub. Date: Nov. 23, 2023

(54) Biodegradable Cork Fabric

(71) Applicant: RTFACT BRANDS, BREST (FR)

(72) Inventor: Ronja NIELSEN, BREST (FR)

(21) Appl. No.: 18/030,503

(22) PCT Filed: Oct. 7, 2021
(86) PCT No.: PCT/IB2021/059192

§ 371 Date: Apr. 6, 2023

(30) Foreign Application Priority Data
Oct. 7, 2020 (FR) 2010239

(51) Int. Cl. B32B 9/04; B32B 5/02; B32B 7/12; B32B 9/02; B32B 37/12; B32B 38/00

(52) U.S. Cl. CPC B32B 9/047; B32B 5/024; B32B 7/12; B32B 9/02; B32B 37/12; B32B 38/0012; B32B 2255/02; B32B 2255/26; B32B 2307/7376; B32B 2307/718; B32B 2317/02; B32B 2305/188; B32B 2262/065; B32B 2250/02; B32B 2307/7163

(57) ABSTRACT

The present invention relates to a fabric comprising three superimposed layers, wherein the first layer is a textile, the second layer is an adhesive and the third layer comprises cork, the fabric being characterised in that the adhesive is a biodegradable water-based adhesive containing at least one polymer. The invention further relates to the method for obtaining said fabric, to the use thereof in the production of objects, as well as to said objects as such.

### FIELD OF THE INVENTION

The present invention relates to a biodegradable fabric with an outer face made of cork, to the process for manufacturing same, and also to the uses of same.

### TECHNOLOGICAL BACKGROUND

Cork is a product present in the bark of certain trees, for example the cork oak, and enables them to protect themselves against the environment (insects, bad weather), and in particular against the cold due to its insulating properties. Thus, cork has been used for many years for its various qualities. For example, remains made from cork dating from 3000 BC have been found in China, Egypt and Persia.

The integration of cork into fabrics to incorporate these qualities therein is relatively recent in retrospect.

For example, in 1901, patent document GB190114420 described a cork fabric that can be used for clothing because of its pleasant feel, its flexibility and its waterproof property. This document discloses that a thin layer of wool, cotton or silk tufts and by then felting or carding this thin adhesive layer of homogeneous material to produce this fabric. It is then reported to be possible to dye the material in order to vary its appearance.

The technical problem that essentially limits the use of this fabric is the delamination of the layers.

Thus, more recently WO2011149370A1 discloses a malleable and moldable cork fabric based on a natural or agglomerated cork matrix, which matrix is impregnated with polymer, such as polyurethane, polyvinyl chloride, poly(ethylene terephthalate), polyester and combinations thereof. This document further discloses a support layer adhesively bonded on the inside, and that the support layer of the invention is chosen from the group comprising woven, non-woven, and knit fabrics, plastic, metallic and wood materials, cork, paper, cardboard, leather and stone.

CN208896590(U) discloses the use of cork to produce a veneer fabric having the characteristics of natural animal skin. The use of a polyurethane resin adhesive layer is disclosed in this document.

KR20170093774(A) and KR20170020984(A) are concerned with producing a functional cork fabric having a multilayer structure, and more particularly a multifunctional cork fabric which is composed of a plurality of layers. One of the technical problems which these documents seek to solve is that of providing a functional cork fabric having a nature-friendly multilayer structure which is not harmful to the human body, while withstanding the pressure of water, and being water resistant and durable for long-term outdoor use. These documents disclose that the functional cork fabric having the multilayer structure may further comprise a coating film formed by a PU coating.

WO2018/135960 relates to a cork fabric comprising, at least, a textile fabric, an adhesive film and a sheet of cork material, which are superposed in layers; a process for manufacturing the cork fabric comprising a step of adhesively bonding at least one sheet of cork material to a first face of a textile fabric by means of an adhesive film, in a range of temperatures from 50° C. to 115° C., and a process for manufacturing cork tapes by cutting the fabric into portions having a width of between 3.0 mm and 50.0 mm, to be used in the manufacture of carpets on a traditional automatic loom. However, this document does not disclose that the adhesives can be biodegradable.

DE202015004764U1 discloses a flexible and stable cork fabric for use in the textile industry, which can be produced without the use of conventional liquid adhesives and which can be produced from sustainably produced materials and which is completely biodegradable. Disclosed is a biodegradable composite material, characterized in that the connection layer is a molten film made from a biodegradable thermoplastic biopolymer or from a blend of biodegradable thermoplastic biopolymers (such as a thermoplastic elastomer (TPE) or a TPE blend, in particular a thermoplastic polyester elastomer (TPE-E) or a TPE-E blend, a polylactide (PLA) or a PLA blend).

DE202014006548U1 discloses a composite material comprising a layer structure composed of a support layer and a cover layer and a tie layer arranged between the support layer and the cover layer. There is provision for the cover layer to include a material containing cork, and for the support layer to include a fibrous material containing regenerated fibers which consists at least partially of Lyocell® material. This document also discloses that the composite material comprises a connection layer with an adhesive. Described in particular are dispersions of copolymers, if appropriate with a mixture of additives, in aqueous solution, it being possible for these to be used particularly advantageously as an adhesive system.

Thus, the prior art discloses examples of fabrics comprising cork, some being described as biodegradable. However, the fabrics referred to as biodegradable that are described involve thermoplastic films which require heavy equipment to implement. The solutions proposed by the prior art for manufacturing a biodegradable cork fabric thus involve processes that are energy-intensive (heating of thermoplastic films) and therefore polluting. In addition, using cotton as a support layer necessarily involves a major ecological impact (the manufacture of cotton is very polluting). Moreover, one of the difficulties encountered in the manufacture of such fabrics incorporating cork in a very thin layer is the control of the external appearance of the fabric. It is particularly difficult to control the appearance associated with the use of an adhesive when the latter is not thermoplastic between the cork and the support layer (typically in the art: cotton). This is because the adhesive will very often pass through the layers and give rise to unsightly marks on the support. However, none of the prior art documents cited above gives a particular incentive to use one adhesive rather than another to avoid unsightly marks on the cork fabric.

The subject matter of the present invention seeks to remedy these drawbacks.

### SUMMARY OF THE INVENTION

The subject matter of the present invention relates to a fabric comprising three superposed layers, wherein the first layer 1 is a textile, the second layer 2 is an adhesive and the third layer 3 comprises cork, characterized in that the adhesive is a biodegradable aqueous-based adhesive comprising at least one polymer and said adhesive advantageously has a melting point of less than 50° C., preferentially less than 20° C.

The subject matter of the present invention also relates to a process for manufacturing a fabric according to the present invention, characterized in that it comprises the following successive steps:
(a) a biodegradable aqueous adhesive is applied to the textile;
(b) a layer of cork is placed over the adhesive of step (a);
(c) the assembly obtained in step (b) is optionally pressed and/or heated, for example at 40° C.; and
(d) the fabric is recovered.

The subject matter of the present invention also relates to the use of the fabric according to the present invention for the manufacture of a garment, a utensil such as a handbag, a shoe or a wallet, or as a covering for an object such as an item of furniture, parts of passenger compartments of cars, headboards or walls.

The subject matter of the present invention also relates to a handbag comprising a fabric according to the present invention.

The subject matter of the present invention additionally relates to a shoe comprising a fabric according to the present invention.

The subject matter of the present invention further relates to a wallet comprising a fabric according to the present invention.

### Definitions

The term “cork” is understood in the context of the present invention to mean the natural material provided by certain trees, including the cork oak, and in particular found in the bark of these trees (according to the commonly found definition of cork).

The term “textile” is understood in the context of the present invention to mean a material capable of being woven or knitted. Initially, it therefore designates a material that can be divided into fibers or textile yarns, such as organic textiles (such as cotton, hemp, flax, wool, etc.) or synthetic textiles (such as textiles made from acrylic fibers, polyolefins, polyester, etc.). The textile may thus be woven or non-woven, knitted or non-knitted, or neither woven nor knitted.

By “biodegradable aqueous-based adhesive” it is understood in the context of the present invention an aqueous-based adhesive which is capable of being decomposed if it is left in the external environment, in particular in the presence of living organisms. By “aqueous-based adhesive”, it is understood in the context of the present invention, an adhesive obtained from an aqueous adhesive (that is to say containing water) that has dried and/or set and thus provides properties of adhesion, that is to say adhesive bonding. The documents EP1085072 and EP2326692 give examples of such adhesives.

By “polymer”, it is understood in the context of the present invention a product resulting from a polymerization reaction. A “polymerization” in the context of the present invention means, as commonly accepted in the art, the chemical reaction in which a plurality of molecules react with one another to form larger molecules, for example in the form of a linear or branched sequence of repeating units.

By “biodegradable aqueous adhesive”, it is understood in the context of the present invention an adhesive as defined above, the product of drying or setting of which, that is to say the aqueous-based adhesive, is biodegradable as defined above.

### DETAILED DESCRIPTION

Fabric as Such

The subject matter of the present invention therefore relates to a fabric as described above, comprising three superposed layers.

However, the subject matter of the present invention also relates to the particular case in which the intermediate layer 2 of adhesive (also called glue) can interpenetrate into the cork layer 3 and/or into the textile layer 1 depending on the porosity of each of these layers, with regard to the viscosity of the glue used. The subject matter of the present invention may therefore relate to a fabric comprising three superposed layers, as described above, comprising at least a portion of the intermediate layer 2 of adhesive interpenetrated into the cork layer 3 and/or into the textile layer 1.

In particular, the subject matter of the present invention relates to a fabric as described above comprising three superposed layers in which the textile layer comprises at least one material capable of being woven or knitted.

More particularly, the subject matter of the present invention relates to a fabric as described above comprising three superposed layers in which the textile layer comprises at least one organic textile material (such as cotton, hemp, flax, wool, etc.) and/or at least one synthetic textile material (such as textiles made from acrylic fibers, polyolefins, polyester, etc.).

The subject matter of the present invention may also relate to a fabric as described above comprising three superposed layers in which the textile layer comprises at least one textile material which may be woven or non-woven, knitted or non-knitted, or neither woven nor knitted.

The subject matter of the present invention may more particularly relate to a fabric as described above, characterized in that the textile comprises at least one of the textiles chosen from the list consisting of polyamide, polyester, polyethylene, polypropylene or other synthetic fibers, regenerated fibers such as viscose, natural fibers such as cotton, flax, hemp and kapok, sheep's or goat's wool and combinations thereof, preferentially comprising at least flax.

Preferably, the subject matter of the present invention more particularly relates to a fabric as described above, characterized in that the textile comprises at least one of the textiles chosen from the list consisting of natural fibers such as cotton, flax, hemp and kapok, sheep's or goat's wool and combinations thereof, preferentially comprising at least flax.

In one particular embodiment, the subject matter of the present invention relates to a fabric as described herein, characterized in that the adhesive comprises at least one, preferentially at least two, constituents in addition to water.

In one embodiment, the biodegradable aqueous-based adhesive used in the context of the present invention comprises between 1% and 90% by mass of water, preferentially between 1% and 90%, between 5% and 85%, between 10% and 80%, between 15% and 75%, between 20% and 70%, between 25% and 65%, between 30% and 60%, between 35% and 55%, or the biodegradable aqueous-based adhesive used in the context of the present invention may comprise between 40% and 50% by mass of water, such as 45% plus or minus 3% by mass of water.

Preferably, said at least two constituents of the adhesive (in addition to water) are polymers.

Preferably, said at least two constituents of the adhesive (in addition to water) are biodegradable polymers.

Preferably, said at least two constituents of the adhesive (in addition to water) are organic polymers.

Preferably, said at least two constituents of the adhesive (in addition to water) are biodegradable organic polymers.

Preferably, said at least two constituents of the adhesive (in addition to water) are biosourced.

The term “biosourced” is understood in the context of the present patent application to mean resulting from a biological process, whether it be found in the natural state (for example a “wild” harvest) or induced by humans (for example via agriculture).

Preferably, said at least two constituents of the adhesive (in addition to water) are biosourced organic polymers, such as starch, dextrin and proteins.

Preferably, said at least two constituents of the adhesive (in addition to water) are organic polymers such as starch, starch derivatives (for example the alkylated and/or acetylated forms of starch), dextrin (for example the alkylated and/or acetylated forms of dextrin), proteins, protein derivatives (for example the alkylated and/or acetylated forms of proteins).

In one particular embodiment, said at least two constituents of the adhesive (in addition to water) are of vegan origin.

In one particular embodiment, said at least two constituents of the adhesive (in addition to water) are not of animal origin.

In one particular embodiment, said at least two constituents of the adhesive (in addition to water) are not of petrochemical origin.

Nevertheless, the subject matter of the present invention may relate to a fabric as described herein, characterized in that the adhesive comprises a vinyl acetate polymer. Specifically, vinyl acetate polymer is a biodegradable polymer.

Preferably, the biodegradable aqueous-based adhesive used in the context of the present invention comprises between 1% and 80% by mass of polyvinyl acetate relative to the total mass of adhesive, preferentially between 10% and 70%, more preferentially between 20% and 60%, even more preferentially between 30% and 55%, for example 42%±10% by mass of polyvinyl acetate relative to the total mass of adhesive.

The subject matter of the present invention may relate to a fabric as described herein, characterized in that the adhesive comprises an aliphatic polyurethane polymer. Specifically, by adapting the amount of aliphatic polyurethane polymer, it is possible to obtain a biodegradable aqueous-based adhesive.

Preferably, the biodegradable aqueous-based adhesive used in the context of the present invention comprises less than 30% by mass of aliphatic polyurethane relative to the total mass of adhesive, preferentially between 1% and 25%, more preferentially between 5% and 20%, even more preferentially between 10% and 15%, by mass of aliphatic polyurethane relative to the total mass of adhesive.

The subject matter of the present invention may relate to a fabric as described herein, characterized in that the adhesive comprises a vinyl acetate copolymer and/or an aliphatic polyurethane polymer

Preferably, the adhesive comprises a vinyl acetate copolymer:aliphatic polyurethane polymer blend of between 0.1:1 and 1:0.1 as dry mass, preferentially between 0.5:1 and 1:0.5 as dry mass, even more preferentially between 0.8:1 and 1:0.8 as dry mass, for example 1:1 as dry mass.

Preferably, the biodegradable aqueous-based adhesive used in the context of the present invention comprises less than 30% by mass of aliphatic polyurethane and between 1% and 60% by mass of polyvinyl acetate relative to the total mass of adhesive, preferentially less than 20% by mass of aliphatic polyurethane and between 10% and 50% by mass of polyvinyl acetate relative to the total mass of adhesive.

Advantageously, the adhesive is not thermoplastic and can be applied at ambient temperature or at a temperature of less than 50° C.

Ambient temperature is understood in the context of the present invention to mean a temperature of between 0° C. and 45° C., preferentially between 5° C. and 40° C., more preferentially between 10° C. and 35° C., such as between 15° C. and 30° C., for instance between 20° C. and 25° C.

Preferably, the biodegradable aqueous-based adhesive used in the context of the present invention has a melting point of less than or equal to 49° C., less than or equal to 48° C., less than or equal to 47° C., less than or equal to 46° C., less than or equal to 45° C., less than or equal to 44° C., less than or equal to 43° C., less than or equal to 42° C., less than or equal to 41° C., less than or equal to 40° C., less than or equal to 39° C., less than or equal to 38° C., less than or equal to 37° C., less than or equal to 36° C., less than or equal to 35° C., less than or equal to 34° C., less than or equal to 33° C., less than or equal to 32° C., less than or equal to 31° C., less than or equal to 30° C., less than or equal to 29° C., less than or equal to 28° C., less than or equal to 27° C., less than or equal to 26° C., less than or equal to 25° C., less than or equal to 24° C., less than or equal to 23° C., less than or equal to 22° C., less than or equal to 21° C., less than or equal to 20° C., less than or equal to 19° C., less than or equal to 18° C., less than or equal to 17° C., less than or equal to 16° C., less than or equal to 15° C., less than or equal to 14° C., less than or equal to 13° C., less than or equal to 12° C., less than or equal to 11° C., less than or equal to 10° C., less than or equal to 9° C., less than or equal to 8° C., less than or equal to 7° C., less than or equal to 6° C., less than or equal to 5° C., less than or equal to 4° C., less than or equal to 3° C., less than or equal to 2° C., or less than or equal to 1° C.

Thus, one of the technical effects is the production of a biodegradable cork fabric that does not require a significant input of heat for its manufacture. The aqueous nature of the adhesive and the limited nature of the textile enable easier manufacture (without strong heating) of the claimed fabric.

However, the biodegradable and/or biosourced fabric that it is desired to produce with the least energy-intensive process possible in the context of the present invention preferentially comprises a face made of biodegradable and/or biosourced fabric (which is for example woven or non-woven, knitted or non-knitted, or neither woven nor knitted) and a face comprising cork. One of the difficulties encountered with the use of aqueous-based adhesives has been that of making the glue invisible after application, since the aqueous adhesive has a tendency to pass through the biodegradable and/or biosourced fabric (which is for example woven or non-woven, knitted or non-knitted, or neither woven nor knitted). Indeed, it has been possible to observe that aqueous glues very often produce unsightly marks on at least one of the faces of the cork fabric that it is desired to produce by passing through the biodegradable and/or biosourced fabric (which is for example woven or non-woven, knitted or non-knitted, or neither woven nor knitted). One of the solutions to this is to adhesively bond two layers of cork on either side of the fabric layer. However, if the desire is to obtain a result in which one of the faces of the cork fabric is made of cork (appearance similar to leather) and the other face is made of fabric (which is for example woven or non-woven, knitted or non-knitted, or neither woven nor knitted), without having to heat the adhesive, this involves using a specific aqueous adhesive.

In one embodiment, the textile is advantageously chosen from polyamide, polyester, polyethylene, polypropylene or other synthetic fibers, regenerated fibers such as viscose, natural fibers such as cotton, flax, hemp and kapok, sheep's or goat's wool and combinations thereof, preferentially comprising at least flax, and the biodegradable aqueous-based adhesive used in the context of the present invention comprises between 1% and 80% by mass of polyvinyl acetate relative to the total mass of adhesive, preferentially between 10% and 70%, more preferentially between 20% and 60%, even more preferentially between 30 and 55, for example 42%±10% by mass of polyvinyl acetate relative to the total mass of adhesive.

In one embodiment, the textile is advantageously chosen from natural fibers such as cotton, flax, hemp and kapok, sheep's or goat's wool and combinations thereof, preferentially flax, and the biodegradable aqueous-based adhesive used in the context of the present invention comprises between 1% and 80% by mass of polyvinyl acetate relative to the total mass of adhesive, preferentially between 10% and 70%, more preferentially between 20% and 60%, even more preferentially between 30 and 55, for example 42%±10% by mass of polyvinyl acetate relative to the total mass of adhesive.

Advantageously, the fabric is chosen from natural fibers such as cotton, flax, hemp and kapok, sheep's or goat's wool and combinations thereof, preferentially flax, and the biodegradable aqueous-based adhesive used in the context of the present invention is of the Pattex Bois Classic® brand (vinyl glue/adhesive based on polyvinyl acetate in aqueous dispersion), in accordance with the teaching of EP2326692.

Preferably, the biodegradable aqueous-based adhesive used in the context of the present invention comprises between 1% and 80% by mass of polyvinyl acetate relative to the total mass of adhesive, preferentially between 10% and 70%, more preferentially between 20% and 60%, even more preferentially between 30% and 55%, for example 42%±10% by mass of polyvinyl acetate relative to the total mass of adhesive.

In one particular embodiment, the fabric according to the present invention comprises a transparent adhesive layer.

In one particular embodiment, the fabric according to the present invention comprises an adhesive layer comprising mineral fillers.

The subject matter of the present invention may relate to a fabric as described herein, characterized in that the third layer comprising cork has a thickness of between 0.05 mm and 1.5 mm, preferentially between 0.1 mm and 0.9 mm.

Thus, the subject matter of the present invention may relate to a fabric as described herein, characterized in that the third layer comprising cork has a thickness of between 0.02 mm and 1.4 mm, between 0.03 mm and 1.3 mm, between 0.04 mm and 1.2 mm, between 0.05 mm and 1.1 mm, between 0.06 mm and 1.0 mm, between 0.07 mm and 0.9 mm, between 0.08 mm and 0.8 mm, between 0.09 mm and 0.7 mm, between 0.1 mm and 0.6 mm, between 0.2 mm and 0.5 mm, or between 0.3 mm and 0.4 mm.

The subject matter of the present invention may relate to a fabric as described herein, characterized in that the textile layer has a mass per unit area of between 200 g/m² and 1000 g/m², for example 690 g/m² preferentially in the case of flax.

More particularly, the subject matter of the present invention relates to a fabric as described herein, characterized in that the textile layer has a mass per unit area of between 250 g/m² and 950 g/m², between 300 g/m² and 900 g/m², between 350 g/m² and 850 g/m², between 400 g/m² and 800 g/m², between 450 g/m² and 750 g/m², between 500 g/m² and 700 g/m², between 550 g/m² and 650 g/m², or between 580 g/m² and 620 g/m².

In the particular case where the textile layer comprises or consists of flax, the subject matter of the present invention may relate to a fabric as described herein, characterized in that the textile layer has a mass per unit area of between 500 g/m² and 900 g/m², between 550 g/m² and 850 g/m², between 600 g/m² and 800 g/m², between 650 g/m² and 750 g/m², or between 680 g/m² and 700 g/m², for example 690 g/m^{2±10} g/m².

The subject matter of the present invention may also relate to a fabric as described herein, characterized in that the grain size of the cork is less than or equal to 1000 micrometers, preferentially less than 800 micrometers.

The term “grain size” is understood according to the present invention to mean the mean diameter of the grains.

More particularly, the subject matter of the present invention relates to a fabric as described herein, characterized in that the grain size of the cork is less than or equal to 950 micrometers, less than or equal to 900 micrometers, less than or equal to 850 micrometers or less or equal to 800 micrometers.

Process for Obtaining

The subject matter of the present invention therefore also relates to a process for manufacturing a fabric according to the present invention, characterized in that it comprises the successive steps (a), (b), (c) and (d) as defined above.

In general, in order to obtain the cork that will be integrated in step (b), the following successive steps (a1 to a7) can be followed:
(a1) a first step of harvesting the cork, in which the cork bark can be harvested from the trees, typically between May and July for example every 9 years;
(a2) a second step of transporting to the factory when the latter is not on site;
(a3) a third step of boiling the cork, in which the bark can be pre-cut into squares and can be put into pallets of for example between 600 and 800 kg. These pallets can be boiled in water. This boiling process enables the destruction of viable forms of insects and fungi;
(a4) a fourth step of drying in which the cork obtained from step (a3) can be left to dry for several months, for example for at least 4 months, and often more. The cork thus obtained is flat by virtue of the previous boiling and can be stored for several years;
(a5) a fifth step of slicing in which the cork can be sliced, for example into equal thick slices, such as 3 equal thick slices (i.e. the cork is laminated in its thickness);
(a6) a sixth optional step of selecting one of the layers from step (a5), for example the intermediate layer when 3 layers have been laminated. Specifically, this selection consists in choosing the layer or layers of best quality, according to the desired color and grain of the cork layers; and
(a7) an optional seventh step of thin slicing in which one or more layers from step (a6), preferentially the best quality layer(s), can be cut into slices of a desired thickness, for example of between 0.3 and 1 mm, such as 0.4 mm (cf. the ranges of values given above for the thickness of the cork layer).

The cork layer thus obtained may thus be integrated in step (b) of the process described above.

The step (c) in which the heating is carried out may be performed at a temperature of between 25 and 60° C., for example between 30 and 50° C., between 35 and 48° C., or between 38 and 45° C., such as 40° C.±1° C.

The step (c) in which the pressing is carried out may be performed at a pressure of between 1 bar and 20 bar, preferentially between 1.5 bar and 10 bar, more preferentially between 2 bar and 6 bar, for example 4 bar+/−10%.

The units “bar” can easily be converted into pascals if necessary since a bar is equivalent to 1×10⁵ Pa.

In one particular embodiment, the step (c) in which the pressing is carried out may be performed at a pressure of between 3 bar and 5 bar, or even more particularly between 3.5 bar and 4.5 bar.

In particular, the subject matter of the present invention relates to a process as described herein, characterized in that it comprises a step (e) of sanding the third layer comprising cork, preferentially after step (b) and/or (c).

In one particular embodiment, the biodegradable aqueous-based adhesive used in step (b) of the process in which a layer of cork is placed over the adhesive of step (a) may comprise less than 5% by mass of organic solvent relative to the total mass of adhesive, preferentially less than 1% by mass of organic solvent, or the biodegradable aqueous-based adhesive used in the context of the present invention is even free of organic solvent.

Indeed, a sanding step can give a smooth result. This sanding step may be carried out by machine or by hand. In one particular embodiment, the sanding of the cork in step (e) is carried out solely by hand.

For example, it is possible for step (e) to start with a preliminary step (el) in which, by virtue of a knife, the superposed parts not adhesively bonded are cut (and hence removed).

There may be two hand sanding steps according to step (e). Both sanding operations can be carried out with abrasive paper.

Step (e) (possibly repeated one, two, three, four or even five times) refines the cork layer. The cork layer may for example lose 0.1 mm with the application of two sanding steps.

Thus, the cork layer may have a thickness of 0.3 mm after step(s) (e).

In one particular embodiment, the process according to the present invention may be characterized in that it comprises an optional step (f) of waxing at least one surface of the fabric obtained after step (b), (c), (d) and/or (e), and preferentially the waxed surface comprises cork.

Indeed, it is possible to use natural or synthetic wax, or even other products to be applied afterwards to make the cork more glossy, for example.

The wax of step (f) may comprise beeswax, paraffin, a leather balm, or an aluminum salt such as alum powder. Preferably, the wax of step (f) is biodegradable and non-toxic.

In one particular embodiment, the process according to the present invention may be characterized in that it comprises an optional step (g) of coloring at least one surface of the fabric obtained after step (b), (c), (d), (e) and/or (f), and preferentially the colored surface comprises cork and/or textile of the fabric according to the present invention.

Any applicable dyeing agent or paint can be used to color the fabric according to the present invention. For example, this may comprise a pigment or dye dissolved or suspended in a liquid. Preferably, the liquid may comprise one or more surfactants, one or more polymers, one or more additives, such as stabilizing additives, and/or water. Preferably, the dyeing agent or paint predominantly comprises water. Thus, in particular, the dyeing agent may comprise a pigment suspended in an organic and/or mineral liquid (such as water).

Preferably, the paint or dyeing agent of step (g) is biodegradable and non-toxic.

DE 202014006548U1 (page 3, 0021) may be mentioned to illustrate the subject of dyeing possibly applicable to the subject matter of the present invention.

Articles Made of Fabric According to the Present Invention

The fabric according to the present invention may be used in the manufacture of numerous articles, for example for the manufacture of a garment, a utensil such as a handbag, a shoe or a wallet, or as a covering for an object such as an item of furniture, parts of passenger compartments of cars, headboards or walls.

Thus, the subject matter of the present invention may relate to a garment comprising a fabric as described herein.

Thus, the subject matter of the present invention may relate to a utensil such as a handbag comprising a fabric as described herein.

Thus, the subject matter of the present invention may relate to a handbag comprising a fabric as described herein.

Thus, the subject matter of the present invention may relate to a shoe comprising a fabric as described herein.

Thus, the subject matter of the present invention may relate to a wallet comprising a fabric as described herein.

Thus, the subject matter of the present invention may relate to a covering for an object such as an item of furniture, parts of passenger compartments of cars, headboards or walls, said covering comprising a fabric as described herein.

### FIGURES

Embodiments of the present invention shall be described hereinafter by way of nonlimiting examples, with reference to the appended figures in which:

FIG. 1 represents a cross-sectional view of a fabric according to the present invention. The figure shows a layer 1 of textile, a second adhesive layer 2 and a third layer 3 comprising or consisting of cork.

FIG. 2 represents an exploded three-dimensional view of a fabric according to the present invention. The figure shows a layer 1 of textile, a second adhesive layer 2 and a third layer 3 comprising or consisting of cork.

FIG. 3 is divided into FIG. 3A and FIG. 3B, which each represent a photograph of the fabric according to the example below in which can be observed the general homogeneity of the appearance of the two faces obtained (FIG. 3A), as well as the textures of the fabric on closer inspection (FIG. 3B).

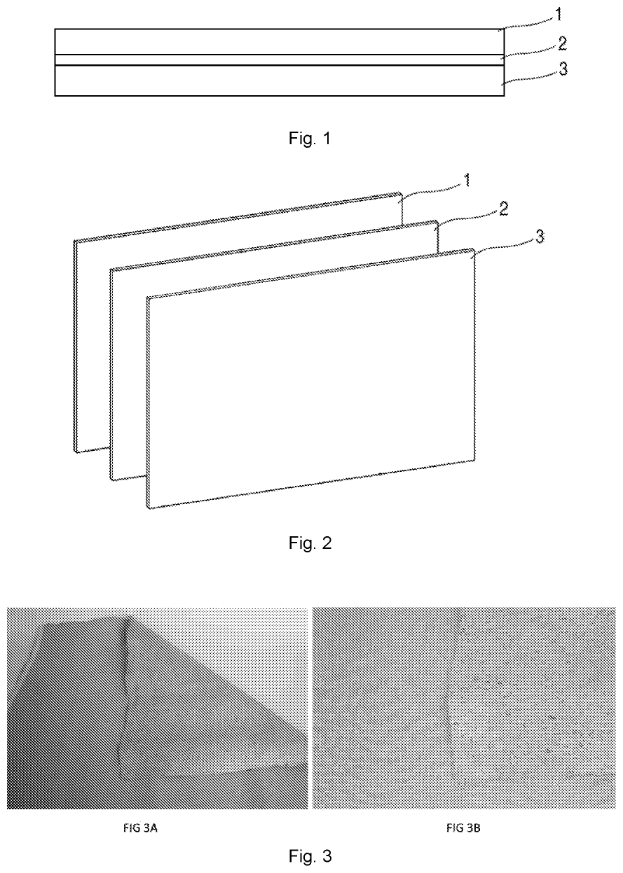

### EXAMPLES

The cork bark was harvested from trees in Portugal, between May and July 2019, with an mean harvest time from each tree of around 9 years since the last harvest.

The bark thus harvested was pre-cut into squares and put into pallets (typically into pallets of between 600 and 800 kg each). These pallets were boiled in water at 100° C. for about 1 hour. This boiling process makes it possible to ensure the destruction of insects and fungi that may be present in the bark collected.

The cork thus obtained after being boiled was left to dry for about 6 months (in Portugal).

The cork is then sliced in its thickness (i.e. laminated) into thick slices of about 0.5 cm to 3 cm depending on the ease of cutting. Typically, a square of cork thus makes it possible to extract 3 thick layers of about 1 cm each.

The best layers were then selected. This selection consists in choosing the layer or layers of best quality, according to the desired color and grain of the cork layers. Typically, these are the “core” layers of the bark, for example the intermediate layer when 3 layers have been produced.

The best layers thus selected were subjected to fine slicing in which they were cut into slices with a thickness of about 0.3-0.5 mm.

A layer of biodegradable aqueous-based adhesive (i.e. an aqueous adhesive, comprising biodegradable polymers) of the Pattex Bois Classic® brand (vinyl glue/adhesive based on polyvinyl acetate in aqueous dispersion, in accordance with the teaching of EP2326692), was applied to a layer of flax (woven, undyed, with a density of 690 g/m²) with a brush (thus a layer of less than about 2 mm, or even less than 1 mm).

The cork layer was applied to the adhesive layer previously deposited on the flax layer.

The multilayer thus formed was then heated to a temperature of 45° C. for 4 minutes and at the same time subjected to a pressure of 4 bar by means of a press.

The resulting product was then sanded twice by hand using abrasive paper, which reduced the thickness by about 0.1 mm to 0.2 mm. The multilayer fabric obtained had a final thickness of about 0.3 mm.

The same process was recently applied with an aqueous-based adhesive comprising less than 20% by mass of aliphatic polyurethane and between 40% and 50% by mass of polyvinyl acetate relative to the total mass of adhesive, with good results.

Of course, the present invention is not limited solely to the embodiments described above by way of nonlimiting examples, but encompasses all similar or equivalent embodiments.

1. A fabric comprising three superposed layers, wherein the first layer is a textile, the second layer is an adhesive and the third layer comprises cork, wherein the adhesive is a biodegradable aqueous-based adhesive comprising at least one polymer.

2. The fabric as claimed in claim 1, wherein the textile comprises at least one of the textiles chosen from the list consisting of polyamide, polyester, polyethylene, polypropylene or other synthetic fibers, regenerated fibers, natural fibers including any one of cotton, flax, hemp and kapok, sheep's or goat's wool and combinations thereof.

3. The fabric as claimed in claim 1, wherein the adhesive comprises at least two constituents in addition to water.

4. The fabric as claimed in claim 1, wherein the adhesive comprises a vinyl acetate copolymer and/or an aliphatic polyurethane polymer.

5. The fabric as claimed in claim 1, wherein the third layer comprising cork has a thickness of between 0.05 mm and 1.5 mm.

6. The fabric as claimed in claim 1, wherein the textile layer has a mass per unit area of between 200 g/m2 and 1000 g/m2.

7. The fabric as claimed in claim 1, wherein the grain size of the cork is less than or equal to 1000 micrometers.

8. A process for manufacturing a fabric as claimed in claim 1, wherein said method comprises the following successive steps:
(a) a biodegradable aqueous adhesive is applied to the textile;
(b) a layer of cork is placed over the adhesive of step (a);
(c) the assembly obtained in step (b) is optionally pressed and/or heated; and
(d) the fabric is recovered.

9. The process as claimed in claim 8, wherein said method comprises a step (e) of sanding the third layer comprising cork.

10. The fabric as claimed in claim 1, said fabric being for any one of a garment, a utensil, a handbag, a shoe or a wallet, or as a covering for an object, an item of furniture, parts of passenger compartments of cars, headboards or walls.

11. The fabric as claimed in claim 2, wherein the regenerated fibers are viscose and the natural natural fibers includes at least flax.

12. The fabric as claimed in claim 5, wherein the third layer comprising cork has a thickness of between 0.1 mm and 0.9 mm.

13. The fabric as claimed in claim 6, wherein the textile layer has a mass per unit area of about 690 g/m2 and 1000 g/m2 in the case of flax.

14. The fabric as claimed in claim 7, wherein the grain size of the cork is less than or equal to 800 micrometers.

15. A process for manufacturing a fabric as claimed in claim 8, wherein in step (c) the assembly obtained in step (b) is optionally pressed and/or heated at 40° C.; and
(d) the fabric is recovered.

16. The process as claimed in claim 9, wherein said method comprises a step (e) of sanding the third layer comprising cork after step (b) and/or (c).
